(19) United States
(12) Patent Application Publication
(10) Pub. No.: US 2026/0326751 A1
(43) Pub. Date: Oct. 22, 2026

(54) MOVEMENT ASSISTANCE SYSTEM, MOVEMENT ASSISTANCE METHOD, AND NON-TRANSITORY COMPUTER-READABLE RECORDING MEDIUM

(71) Applicant: TOYOTA JIDOSHA KABUSHIKI KAISHA, Aichi-ken (JP)

(72) Inventor: Yusuke FUKUI, Miyoshi-shi (JP)

(21) Appl. No.: 19/641,521

(22) Filed: Apr. 8, 2026

(30) Foreign Application Priority Data
Apr. 17, 2025 (JP) 2025-068060

(51) Int. Cl. B60W 30/09; B60W 10/18; B60W 10/20; B60W 30/095; B60W 50/14; G06T 7/70; G06V 20/54; G06V 40/10; G08G 1/16

(52) U.S. Cl. CPC B60W 30/09; B60W 10/18; B60W 30/0956; B60W 50/14; G06T 7/70; G06V 20/54; G06V 40/10; G08G 1/164; G08G 1/166; B60W 10/20; B60W 2554/4029; G06T 2207/30201; G06T 2207/30232; G06T 2207/30236; G06V 2201/08

(57) ABSTRACT

A movement assistance system acquires object information around a moving body using one or more sensors included in one or more external systems that perform wireless communication with the moving body. When detecting a pedestrian around the moving body based on the object information, the system acquires pedestrian information including the position and facial direction of the pedestrian, from the object information, generates, based on the pedestrian information, a field-of-vision image that represents the result of prediction of a field of vision of the pedestrian in a virtual space based on the object information, inputs, to a multimodal generative AI model, input information including the field-of-vision image and a prompt that instructs an output of output information indicating the result of determination as to whether or not the moving body is present in the field-of-vision image, and causes the multimodal generative AI model to output the output information.

### CROSS-REFERENCES TO RELATED APPLICATION

The present disclosure claims priority under 35 U.S.C. § 119 to Japanese Patent Application No. 2025-068060, filed on Apr. 17, 2025, which is incorporated herein by reference in its entirety.

### BACKGROUND

### Technical Field

The present disclosure relates to a technique for assisting the movement of a moving body.

### Background Art

JP 2009-202676 A discloses a travel assistance device for a vehicle. The travel assistance device detects a direction of the face of a pedestrian using a pedestrian detection unit that uses a sensor (e.g., an image recognition sensor) equipped with the vehicle, and estimates the field of vision of the pedestrian from the detected direction of the face. Further, when the vehicle is within the estimated field of vision, the travel assistance device sets an avoidance area that is smaller than that when the vehicle is not within the field of vision, and drives the vehicle to the destination without passing through this avoidance area.

Moreover, JP 2020-030718 A discloses an in-vehicle device of a vehicle. When a pedestrian approaches within a predetermined distance from the vehicle, the in-vehicle device transmits guidance direction information to a pedestrian device to guide the pedestrian to look in the direction of the vehicle. Further, when the pedestrian does not visually check the vehicle, the in-vehicle device transmits alert information to the pedestrian device to request the pedestrian to pay attention to the vehicle.

### SUMMARY

In order to realize a movement assistance system that can more appropriately assist the movement of a moving body, it is desirable to be able to more appropriately grasp future information on a pedestrian after the pedestrian is detected in the vicinity of the moving body.

The present disclosure has been made in view of the problem described above, and an object thereof is to provide a technique that can assist the movement of a moving body while more appropriately understanding a pedestrian around the moving body.

A movement assistance system according to the present disclosure assists the movement of a moving body, and includes one or more sensors and one or more processors. The one or more sensors are included in one or more external systems that perform wireless communication with the moving body. The one or more processors are configured to: acquire object information around the moving body using the one or more sensors; and when detecting a pedestrian around the moving body based on the object information, execute field-of-vision prediction processing and moving body presence determination processing. The field-of-vision prediction processing includes: acquiring pedestrian information including the position and facial direction of the pedestrian, from the object information; and field-of-vision image generation processing of generating, based on the pedestrian information, a field-of-vision image that represents the result of prediction of a field of vision of the pedestrian in a virtual space based on the object information. The moving body presence determination processing includes: inputting, to a multimodal generative AI model, input information including the field-of-vision image and a prompt that instructs an output of output information indicating the result of determination as to whether or not the moving body is present in the field-of-vision image; and causing the multimodal generative AI model to output the output information.

A movement assistance method according to the present disclosure is executed by a computer to assist the movement of a moving body. The movement assistance method includes: acquiring object information around the moving body using one or more sensors included in one or more external systems that perform wireless communication with the moving body; and when detecting a pedestrian around the moving body based on the object information, executing field-of-vision prediction processing and moving body presence determination processing. The field-of-vision prediction processing includes: acquiring pedestrian information including a position and facial direction of the pedestrian, from the object information; and field-of-vision image generation processing of generating, based on the pedestrian information, a field-of-vision image that represents the result of prediction of a field of vision of the pedestrian in a virtual space based on the object information. The moving body presence determination processing includes: inputting, to a multimodal generative AI model, input information including the field-of-vision image and a prompt that instructs an output of output information indicating the result of determination as to whether or not the moving body is present in the field-of-vision image; and causing the multimodal generative AI model to output the output information.

A non-transitory computer-readable recording medium according to the present disclosure stores a movement assistance program executed by a computer to assist the movement of a moving body. The movement assistance program causes the computer to execute: acquiring object information around the moving body using one or more sensors included in one or more external systems that perform wireless communication with the moving body; and when detecting a pedestrian around the moving body based on the object information, executing field-of-vision prediction processing and moving body presence determination processing. The field-of-vision prediction processing includes: acquiring pedestrian information including a position and facial direction of the pedestrian, from the object information; and field-of-vision image generation processing of generating, based on the pedestrian information, a field-of-vision image that represents the result of prediction of a field of vision of the pedestrian in a virtual space based on the object information. The moving body presence determination processing includes: inputting, to a multimodal generative AI model, input information including the field-of-vision image and a prompt that instructs an output of output information indicating the result of determination as to whether or not the moving body is present in the field-of-vision image; and causing the multimodal generative AI model to output the output information.

According to the present disclosure, when a pedestrian present around the moving body is detected based on the object information, field-of-vision prediction processing and moving body presence determination processing are executed. This makes it possible to assist the movement of the moving body while more appropriately grasping predicted information on the field of vision of the pedestrian after the pedestrian is detected around the moving body.

### BRIEF DESCRIPTION OF THE DRAWINGS

FIG. 1 is a schematic diagram showing an example of a configuration of a travel assistance system according to an embodiment;

FIG. 2 is a flowchart showing an example of flow of processing related to travel assistance according to an embodiment;

FIG. 3 is a diagram showing an example of a scene in which a pedestrian present around a vehicle is detected;

FIG. 4A shows an example of a field-of-vision image according to an embodiment;

FIG. 4B shows another example of the field-of-vision image according to an embodiment; and

FIG. 5 is a flowchart showing another example of flow of processing related to the travel assistance according to an embodiment.

### DETAILED DESCRIPTION

Embodiments of the present disclosure will be described with reference to the accompanying drawings.

A “movement assistance system” according to the present disclosure is a system that assists the movement of a moving body. Examples of the moving body include a vehicle (e.g., an automobile), and a robot (e.g., a logistics robot). In the following description, a movement assistance system (i.e., a travel assistance system) applied to a vehicle, which is an example of the moving body, will be considered as an example. When generalizing, the term “vehicle” in the following description should be read as “moving body”.

### 1. Configuration of Travel Assistance System

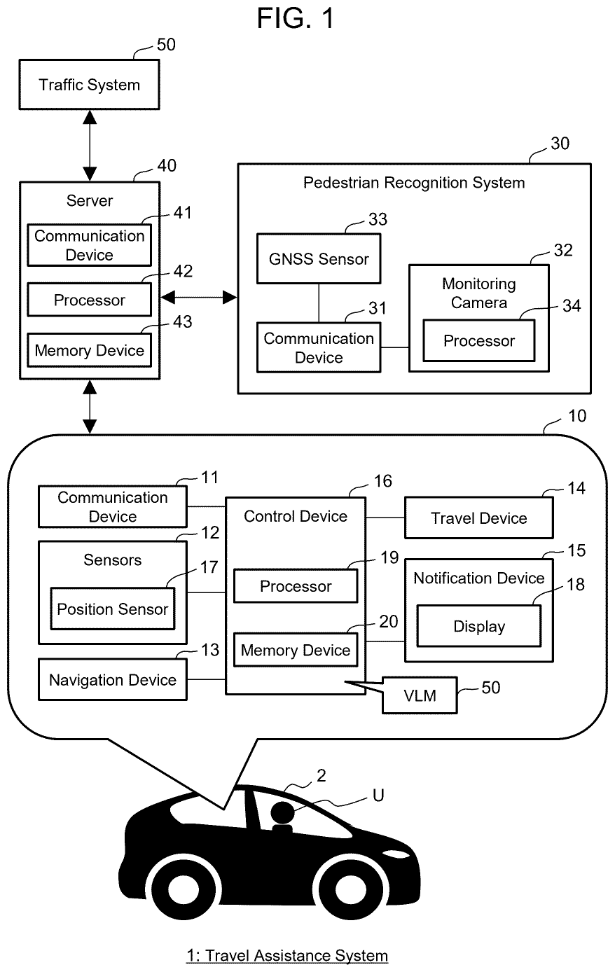

FIG. 1 is a schematic diagram showing an example of the configuration of a travel assistance system 1 according to the present embodiment. The travel assistance system 1 according to the present embodiment is a system that assists the travel of a vehicle 2. The travel assistance system 1 includes, for example, an in-vehicle system 10, a pedestrian recognition system 30, and a server 40.

In one example, the vehicle 2 is a vehicle operated (driven) by a user U. The travel assistance system 1 is a system that assists the travel of the vehicle 2 by, for example, assisting the user U in driving the vehicle 2. However, the vehicle to which the travel assistance system 1 is applied may be an automated driving vehicle. Furthermore, the user U is, for example, a driver who gets into the vehicle 2 and drives the vehicle 2, but may also remotely operate the vehicle 2 from outside the vehicle 2 using a remote operation device.

The in-vehicle system 10 includes a communication device 11, sensors 12, a navigation device 13, a travel device 14, a notification device 15, and a control device 16.

The communication device 11 performs wireless communication with the outside of the vehicle 2. For example, the communication device 11 performs wireless communication with the pedestrian recognition system 30 via the server 40. The communication device 11 also performs wireless communication with a traffic system 50 via the server 40. The traffic system 50 generates traffic situation information TS that indicates the traffic situations of roads within an area in which the vehicle 2 travels, and transmits the traffic situation information TS to an external device or system, such as the server 40. Examples of the traffic situation information TS include traffic congestion information, traffic control information, and traffic light display information. Alternatively, the communication device 11 may directly communicate wirelessly with each of the pedestrian recognition system 30 and the traffic system 50.

The sensors 12 are equipped with the vehicle 2 and include, for example, a position sensor 17 and a vehicle state sensor. The position sensor 17 detects the position and orientation of the vehicle 2. For example, the position sensor 17 includes a Global Navigation Satellite System (GNSS) sensor. The vehicle state sensor detects the state of the vehicle 2 (for example, vehicle speed, yaw rate, acceleration, steering angle). The sensors 12 do not include a recognition sensor (e.g., a camera, a LIDAR (Laser Imaging Detection and Ranging), a radar, a sonar) that recognizes (detects) the surrounding situation of the vehicle 2. However, the sensors 12 may also include a recognition sensor that is used for a purpose other than travel assistance TA described below.

The navigation device 13 generates a planned travel route R (planned movement route) for the vehicle 2 based on, for example, information from the sensors 12 and the traffic system 50 as well as destination information received from the user U. The travel device 14 includes a drive device, a steering device, and a brake device. The drive device includes one or both of an electric motor and an internal combustion engine for driving the vehicle 2. The steering device includes an electric motor that steers the wheels. The brake device includes a brake actuator for braking the vehicle 2. In addition, the travel device 14 corresponds to one or more actuators for traveling (moving) the vehicle 2 (moving body).

The notification device 15 notifies the user U of information. The notification device 15 includes a display 18. The display 18 is, for example, a head-up display (HUD) that displays information on the front windshield of the vehicle 2, or a display installed on the instrument panel. The notification device 15 may include a speaker for notifying the user U by voice or sound. The notification device 15 may include a vibration device for notifying the user U through the sense of touch. The vibration device may be attached to the steering wheel, for example.

The control device 16 controls the vehicle 2. The control device 16 includes one or more processors 19 (hereinafter, simply referred to as a processor 19) and one or more memory devices 20 (hereinafter, simply referred to as a memory device 20). The processor 19 executes various kinds of processing including those related to travel assistance TA described below. Examples of the processor 19 include a general purpose processor, a specific purpose processor, a central processing unit (CPU), a graphics processing unit (GPU), an application specific integrated circuit (ASIC), and a field-programmable gate array (FPGA). The processor 19 may also be referred to as processing circuitry. Examples of the memory device 20 include a volatile memory, a non-volatile memory, a hard disk drive (HDD), and a solid state drive (SSD). The functions of the control device 16 may be realized by cooperation between the processor 19 that executes a computer program and the memory device 20. The computer program is stored in the memory device 20. Alternatively, the computer program may be recorded in a non-transitory computer-readable recording medium or provided via a network.

The memory device 20 stores various kinds of information necessary for the various kinds of processing. The various kinds of information includes a map database. The processor 19 acquires map information M of the required area from the map database. The map information M includes a general navigation map. The map information M may also indicate lane layout and road shapes. The map information M may include location information on, for example, structures, traffic lights, and signs. The map database may be stored in an external system, such as the server 40. Further, the various kinds of information stored in the memory device 20 includes various kinds of sensor information SEN detected by the sensors 12 (e.g., position information POS1 on the vehicle 2 based on the position sensor 17).

For example, a plurality of pedestrian recognition systems 30 are installed in an area where the vehicle 2 travels. Each of the pedestrian recognition systems 30 includes a communication device 31, a monitoring camera 32, and a GNSS sensor 33. The communication device 31 performs wireless communication with the server 40. The monitoring camera 32 is installed so as to capture images of the road on which the vehicle 2 is traveling and the surroundings of the road. More specifically, for example, the monitoring camera 32 captures images of a sidewalk that intersects with the roadway on which the vehicle 2 is traveling and the surroundings of the sidewalk.

The monitoring camera 32 includes a processor 34. The processor 34 analyzes an image IMG acquired by the monitoring camera 32 to recognize an object included in the image IMG and acquire object information on the object. The recognized objects include pedestrians. Objects recognized other than pedestrians include structures (e.g., buildings, curbs, guardrails, utility poles, pedestrian bridges), trees, bicycles, motorcycles, other vehicles (e.g., preceding vehicles, following vehicles, oncoming vehicles, parked vehicles), white lines, stop lines, traffic lights, signs, and obstacles. More specifically, the object information indicates, for example, the relative position of the object with respect to the monitoring camera 32. The object information may indicate the relative speed of the object with respect to the monitoring camera 32. The object information may indicate the type of the object. The object information may indicate the posture of the object. For example, by analyzing the image IMG acquired by the monitoring camera 32, the processor 34 can identify an object and calculate the relative position of the object. Further, by using an object detection model based on machine learning, the processor 34 can detect an object appearing in the image IMG and recognize the type of the object. Further, by using a posture estimation model based on machine learning, the processor 34 can estimate the posture of an object appearing in the image IMG. The object information may include trajectory information acquired by tracking the recognized object.

When the vehicle 2 is traveling in the vicinity of the monitoring camera 32, the above-described object information corresponds to “object information in the vicinity of the vehicle 2 (hereinafter, referred to as object information TO)”. Therefore, the monitoring camera 32 corresponds to an example of the “one or more sensors” according to the present disclosure.

The GNSS sensor 33 is used to acquire position information POS2 of the monitoring camera 32. The processor 34 can identify the position of the object based on the position information POS2. The communication device 31 transmits the object information (including the object information TO) acquired using the monitoring camera 32 to the server 40 together with the position information POS2. In addition, the pedestrian recognition system 30 may include a memory device that stores the acquired object information (including the object information TO).

The server 40 is, for example, a cloud server, and includes a communication device 41, one or more processors 42 (hereinafter, simply referred to as a processor 42), and one or more memory devices 43 (hereinafter, simply referred to as a memory device 43). The communication device 41 performs wireless communication with each of the vehicle 2, the pedestrian recognition system 30, and the traffic system 50. The processor 42 executes various kinds of processing. The processor 42 may also be referred to as processing circuitry. Examples of the processor 42 include a general purpose processor, a special purpose processor, a CPU, a GPU, an ASIC, and an FPGA. The memory device 43 stores various kinds of information necessary for the various kinds of processing. Examples of the memory device 43 include a volatile memory, a non-volatile memory, an HDD, and an SSD. The functions of the server 40 may be realized by cooperation between the processor 42 that executes a computer program and the memory device 43. The computer program is stored in the memory device 43. Alternatively, the computer program may be recorded in a non-transitory computer-readable recording medium or provided via a network.

The server 40 manages various kinds of information used in the travel assistance system 1. Specifically, the server 40 stores the object information (including the object information TO) received from each of the pedestrian recognition systems 30 in the memory device 43 together with the position information POS2. The server 40 receives the traffic situation information TS for each location on the planned travel route R of the vehicle 2 from the traffic system 50 and stores the received traffic situation information TS in the memory device 43. The server 40 receives the sensor information SEN (e.g., the position information POS1 on the vehicle 2) and the planned travel route R from the in-vehicle system 10 and stores the received sensor information SEN and planned travel route R in the memory device 43.

Based on the position information POS1 on the vehicle 2 and the position information POS2 on each monitoring camera 32, the server 40 (processor 42) can acquire the object information from the pedestrian recognition system 30 located in the vicinity of the vehicle 2, i.e., the object information TO related to an object in the vicinity of the vehicle 2. When a pedestrian is included in the objects, the acquired object information TO includes pedestrian information PED. The pedestrian information PED includes information on the position and facial direction of the pedestrian. The pedestrian information PED may further include, for example, information on at least one of the speed, posture, and trajectory of the pedestrian.

The travel assistance system 1 according to the present embodiment uses a large-scale vision-language model (VLM) 50 (see FIG. 1) for “travel assistance TA” described below. The VLM 50 is a generative AI model that processes visual information (images or videos) and text information (language data) in an integrated manner. Examples of the VLM50 include GPT-4, Gemini, CLIP, and DALL-E. In the configuration example shown in FIG. 1, the control device 16 of the in-vehicle system 10 includes the VLM 50. Alternatively, the server 40 may include the VLM 50, or another external system included in the travel assistance system 1 may include the VLM 50. In addition, the VLM 50 corresponds to an example of the “multimodal generative AI model” according to the present disclosure.

Additionally, in the configuration example shown in FIG. 1, the pedestrian recognition system 30 corresponds to an example of the “one or more external systems” according to the present disclosure. Another example of the “one or more external systems” is an in-vehicle system installed in another vehicle (another moving body) traveling around the vehicle 2. That is, the object information TO may be acquired using, for example, a recognition sensor (one or more sensors) included in the in-vehicle system of the another vehicle. In yet another example, the travel assistance system 1 may not include the server 40 but may include an in-vehicle system configured to have the functions of the server 40.

### 2. Travel Assistance (Movement Assistance)

The travel assistance provided by the travel assistance system 1 includes travel assistance TA that assists the travel of the vehicle 2 based on the pedestrian information PED of a pedestrian X present in the vicinity of the vehicle 2. The following description will be given taking travel assistance TA for assisting the user U in driving the vehicle 2, for example. However, the travel assistance TA may also be assistance in autonomous traveling, which is performed for an automated driving vehicle based on the pedestrian information PED.

In the present embodiment, when the travel assistance system 1 detects a pedestrian X present in the vicinity of the vehicle 2 based on the object information TO, the travel assistance system 1 executes “field-of-vision prediction processing” and “moving body presence determination processing” as follows.

The field-of-vision prediction processing includes acquiring the pedestrian information PED including the position and facial direction of the pedestrian X from the object information TO. The field-of-vision prediction processing also includes generating, based on the acquired pedestrian information PED, a field-of-vision image VFI that represents the result of prediction of the field of vision FOV of the pedestrian X in a virtual space based on the object information TO (field-of-vision image generation processing). An example of the virtual space mentioned here is a simulation space SS described below (see step S104).

The moving body presence determination processing includes inputting input information MI, which includes the generated field-of-vision image VFI and a prompt PT, to the VLM 50 and causing the VLM 50 to output output information MO. The prompt PT is an instruction to the VLM 50 to output the output information MO. The output information MO is information indicating the result of determination as to whether or not the vehicle 2 is present in the field-of-vision image VFI.

### 2-1. Example of Processing Flow

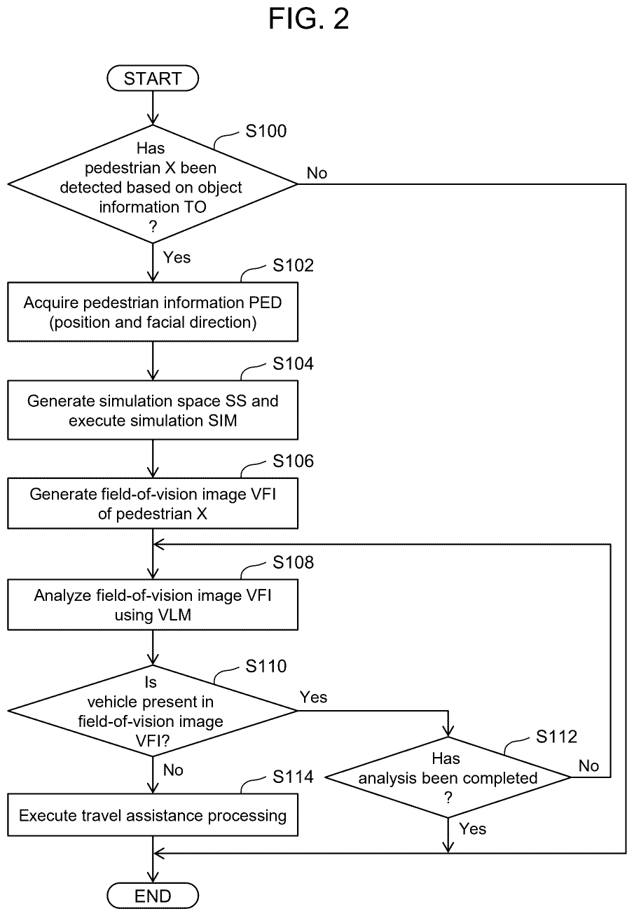

FIG. 2 is a flowchart showing an example of the flow of processing related to the travel assistance TA according to the present embodiment. The processing of this flowchart is executed by, for example, the processor 19 of the in-vehicle system 10.

In step S100, the processor 19 determines whether or not a pedestrian X has been detected, based on the object information TO. Specifically, for example, the in-vehicle system 10 transmits the position information POS1 on the vehicle 2 to the server 40, and acquires the object information TO corresponding to the position information POS1 from the server 40 at predetermined intervals. The acquired object information TO may be stored in the memory device 20. The processor 19 determines whether or not the pedestrian X is present in the vicinity of the vehicle 2, based on the acquired object information TO. As a result, when the pedestrian X is not detected (step S100: No), the processing proceeds to END. On the other hand, when the pedestrian X is detected (step S100: Yes), the processing proceeds to step S102.

In step S102, the processor 19 acquires the pedestrian information PED related to the detected pedestrian X from the object information TO. As described above, the pedestrian information PED includes at least the position and facial direction of the detected pedestrian X. Thereafter, the processing proceeds to step S104.

In step S104, the processor 19 generates (constructs) a simulation space SS. The simulation space SS is a three-dimensional virtual space (cyberspace) in which a simulation SIM is performed to predict the field of vision FOV of a pedestrian X detected in the vicinity of the vehicle 2. The processor 19 generates the simulation space SS based on the object information TO. For example, the processor 19 generates the simulation space SS by utilizing an existing technique for generating three-dimensional models to reconstruct, based on the object information TO, the three-dimensional environment around the vehicle 2 in which the pedestrian X is present. In addition, the processor 19 may generate the simulation space SS based on, for example, at least one of information on the image IMG captured by the monitoring camera 32 and the map information M, together with the object information TO.

The processor 19 executes the simulation SIM using the generated simulation space SS. The simulation SIM is executed for a target period of the above-described prediction (i.e., a prediction target period P). The prediction target period P is a future period with respect to the time when the pedestrian X is detected, and corresponds to the period during which the vehicle 2 traveling (moving) along the planned travel route R approaches the pedestrian X. The predicted target period P is determined (calculated) based on, for example, the position information on the pedestrian X included in the pedestrian information PED, the position information POS1 and speed information of the vehicle 2 included in the sensor information SEN, and the planned travel route R. More specifically, for example, the processor 19 executes the simulation SIM at each of a plurality of times ti (i=1 to n) that arrive in order at each predetermined time T during the prediction target period P (i.e., in chronological order). The processor 19 stores, in the memory device 20, three-dimensional model data MD, which is information indicating the result of the simulation SIM in the simulation space SS (i.e., the result of the above-described prediction).

The processor 19 executes the simulation SIM, for example, as follows, based on the object information TO including the pedestrian information PED. That is, the processor 19 uses the pedestrian information PED including past data on the position and facial direction of the pedestrian X for the simulation SIM. The simulation SIM is executed to predict whether or not the pedestrian X will move and predict the movement path of the pedestrian X, based on past data on the position of the pedestrian X. Further, the simulation SIM is executed to predict whether or not the facial direction of the pedestrian X will change and how the facial direction will change, based on the past data on the facial direction of the pedestrian X. The general human viewing angle is used as the viewing angle of the pedestrian X. Furthermore, the simulation SIM may be executed while making a predictive determination as to whether or not the vehicle 2 traveling along the planned travel route R is likely to come into contact with the pedestrian X. If a determination result indicating that the risk of the contact has disappeared is obtained at one of the times ti (for convenience, referred to as “time tz”), the simulation SIM may be executed to end at the time tz. By executing the simulation SIM in this manner, the processor 19 acquires the result of the prediction of the field of vision FOV of the pedestrian X at each time ti. In addition, the simulation SIM does not necessarily have to be performed for a plurality of times ti during the prediction target period P, but may be performed for only one time t1.

Furthermore, the processor 19 may execute the simulation SIM based not only on the pedestrian information PED but also on the traffic situation information TS indicating the traffic situation around the detected pedestrian X. The traffic situation information TS is acquired from the traffic system 50 via the server 40. For example, the traffic light display information (traffic situation information TS) on a pedestrian traffic light installed at a crosswalk around the pedestrian X may be used to predict the field of vision FOV of the pedestrian X in the simulation SIM.

In step S106 subsequent to step S104, the processor 19 generates a field-of-vision image VFI of the pedestrian X. The field-of-vision image VFI is an image acquired in the simulation space SS. Therefore, the field-of-vision image VFI represents the result of the prediction of the field of vision FOV of the pedestrian X at the time ti during the prediction target period P. The processor 19 generates the field-of-vision image VFI at each corresponding time ti from the three-dimensional model data MD at each time ti, using, for example, an existing rendering technique. That is, the processor 19 acquires the field-of-vision images VFI in chronological order for the prediction target period P. In addition, the processing of steps S102-106 correspond to an example of the “field-of-vision prediction processing” including the “field-of-vision image generation processing” (step S106).

In step S108 subsequent to step S106, the processor 19 uses the VLM 50 to analyze the acquired field-of-vision images VFI. To be specific, the processor 19 generates a prompt PT that instructs the output of the output information MO that indicates the result of the determination as to whether or not the field of vision FOV of the pedestrian X is present in the field-of-vision image VFI. The processor 19 inputs the input information MI, which includes the generated prompt PT together with the field-of-vision image VFI, to the VLM 50. The processor 19 then acquires the output information MO output from the VLM 50. More specifically, the processor 19 inputs the input information MI to the VLM 50 and acquires the output information MO from the VLM 50 in chronological order while updating the field-of-vision image VFI input to the VLM 50. Therefore, when the processing first proceeds to step S108, the processor 19 first performs analysis by the VLM 50 on the field-of-vision image VFI at the time t1. The processing then proceeds to step S110.

In step S110, the processor 19 determines whether or not the pedestrian X is present in the field-of-vision image VFI, based on the acquired output information MO. As a result, when the output information MO indicates that the pedestrian X is present in the field-of-vision image VFI (step S110: Yes), the processing proceeds to step S112. In step S112, the processor 19 determines whether the analysis by the VLM 50 has been completed, i.e., whether the output of the output information MO for all of the time-series field-of-vision images VFI generated in step S106 is complete.

When the analysis is complete (step S112: Yes), the processing proceeds to END. On the other hand, when the analysis is not completed (step S112: No), the processing returns to step S108. As a result, in step S108, the processor 19 performs the analysis by the VLM 50 on the field-of-vision image VFI at the next time i (e.g., time t2). When the determination result in step S110 becomes Yes again as a result of this analysis, the processing returns to step S108 again on the condition that the determination result in step S112 is No. The same applies below. As just described, the processing of step S108 (analysis by the VLM 50) is repeatedly executed (in other words, executed in chronological order) until the determination result in step S110 becomes No or the determination result in step S112 becomes Yes.

On the other hand, when the output information MO indicates that the pedestrian X is not present in the field-of-vision image VFI (step S110: No), the processing proceeds to step S114. In addition, the processing of steps S108 to S112 corresponds to an example of “moving body presence determination processing”.

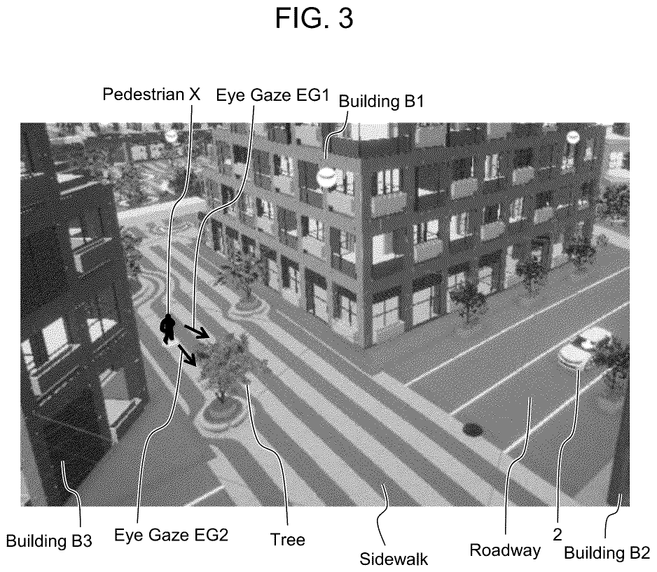

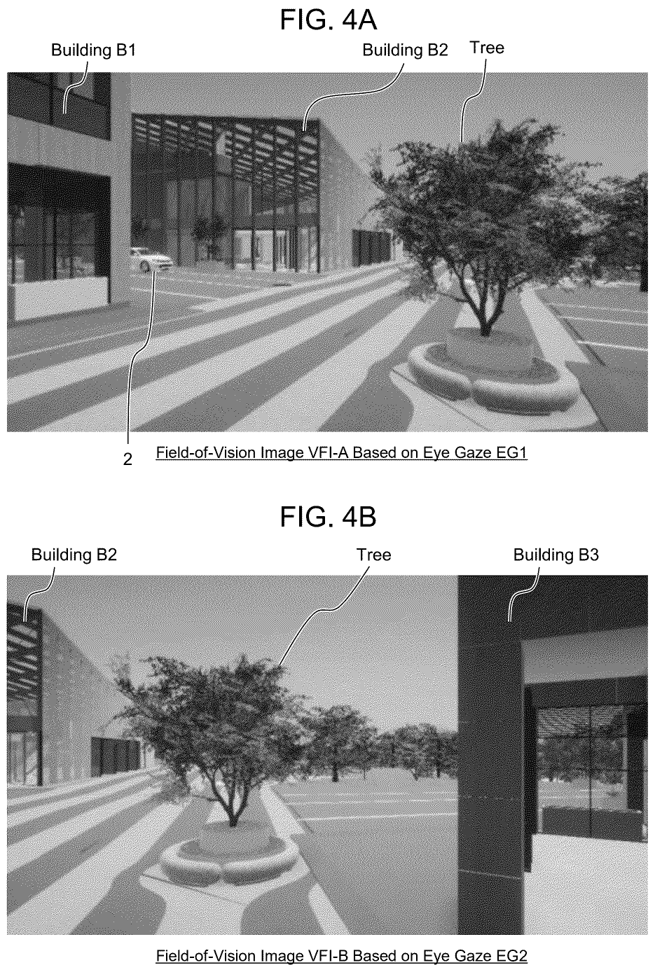

Here, the explanation of the processing of step S110 will be supplemented with reference to FIGS. 3, 4A, and 4B. FIG. 3 is a diagram showing an example of a scene in which a pedestrian X present around the vehicle 2 is detected. FIG. 3 shows a pedestrian X on a sidewalk and a vehicle 2 traveling on a roadway intersecting the sidewalk. In addition, there are other objects, such as buildings B1-B3 and trees, around the pedestrian X. FIGS. 4A and 4B show field-of-vision images VFI-A and VFI-B, respectively, which are examples of the field-of-vision image VFI. The field-of-vision image VFI-A represents the field of vision FOV based on the eye gaze (i.e., line of sight) EG1 of the pedestrian X shown in FIG. 3 for the purpose of explanation. In the field-of-vision image VFI_A, the vehicle 2 is present along with the same buildings B1 and B2 and tree as those shown in FIG. 3. That is, in this example, it can be determined that the eye gaze EG1 of the pedestrian X is directed toward the vehicle 2. On the other hand, the field-of-vision image VFI_B represents the field of vision FOV based on the eye gaze EG2 of the pedestrian X (see FIG. 3). In the field-of-vision image VFI_B, the buildings B2 and B3 and tree are present, but the vehicle 2 is not present. That is, in this example, it can be determined that the eye gaze EG2 of the pedestrian X is not directed toward the vehicle 2.

In step S114, the processor 19 executes travel assistance processing (movement assistance processing) that assists the travel of the vehicle 2, provided that a predetermined execution condition A based on the pedestrian information PED (e.g., the position, speed, posture, and trajectory of the pedestrian X) is met. For example, the execution condition A may include a condition that the distance between the pedestrian X and the planned travel route R is shorter than a predetermined distance. Further, the execution condition A may include a condition that the pedestrian X approaches the planned travel route R at a speed higher than a predetermined speed.

For example, in the travel assistance processing, the processor 19 executes a notification N to notify the user U of the presence of the pedestrian X via the notification device 15, based on the pedestrian information PED related to the detected pedestrian X. As just described, the notification N may be performed to alert the user U to the presence of the pedestrian X. More specifically, the notification N may inform the user U that the eye gaze of the pedestrian X is not directed toward the vehicle 2 (in other words, that the pedestrian X may not be aware of the vehicle 2).

The notification N using the notification device 15 can be performed using, for example, at least one of voice (e.g., “There is a pedestrian ahead to the right who has not seen this vehicle”, “There is a pedestrian ahead to the right who has not noticed this vehicle”), message (specific examples are the same as above), warning sound, and vibration. The user U to whom the notification N is sent is, for example, the user U who is driving the vehicle 2. Alternatively, the notification N may be sent to a user U who is not driving but is riding in the vehicle 2 being an automated driving vehicle, or may be sent via a remote operation device to a user U who is remotely operating the vehicle 2 from the outside using the remote operation device.

Moreover, the notification N to notify the presence of the pedestrian X may be sent to, instead of the user U, for example, a device (a device mounted on the vehicle 2) that controls the travel device 14 to perform travel control C (movement control) described below. The device is, for example, a travel control electronic control unit (travel control ECU) included in the control device 16. In this example, one or more processors included in the travel control ECU correspond to a part of the one or more processors 19. More specifically, in an example in which the control device 16 includes, together with the travel control ECU, an information processing ECU that executes the field-of-vision prediction processing and the moving body presence determination processing, one or more processors of the information processing ECU (corresponding to another part of the one or more processors 19) may execute the notification N to the travel control ECU. This also applies when the vehicle to which the travel assistance system 1 is applied is an automated driving vehicle. In addition, the notification N may be sent to both the user U (notification device 15) and the travel control ECU.

Furthermore, in an example in which the travel control ECU is the target of the notification N, the processor 19 performs the travel control C to avoid a collision between the vehicle 2 and the pedestrian X, based on the pedestrian information PED related to the detected pedestrian X. For example, at least one of brake control for automatically braking the vehicle 2 to avoid a collision and steering control for automatically steering the wheels to avoid a collision corresponds to the travel control C. Further, with regard to this brake control, the processor 19 may, for example, relax an activation start condition of the brake control (i.e., a collision determination condition), which is an example of the above-described execution condition A, as follows, in order to make the brake control easier to activate. That is, when the output information MO indicates that the vehicle 2 is not present in the field-of-vision image VFI, the processor 19 may relax the activation start condition compared to when the output information MO indicates that the vehicle 2 is present in the field-of-vision image VFI. This also applies when the vehicle to which the travel assistance system 1 is applied is an automated driving vehicle. Also, in an example in which the user U is the target of the notification N, the processor 19 may perform the travel control C in conjunction with the notification N. After step S114, the processing proceeds to END.

### 2-2. Another Example of Processing Flow

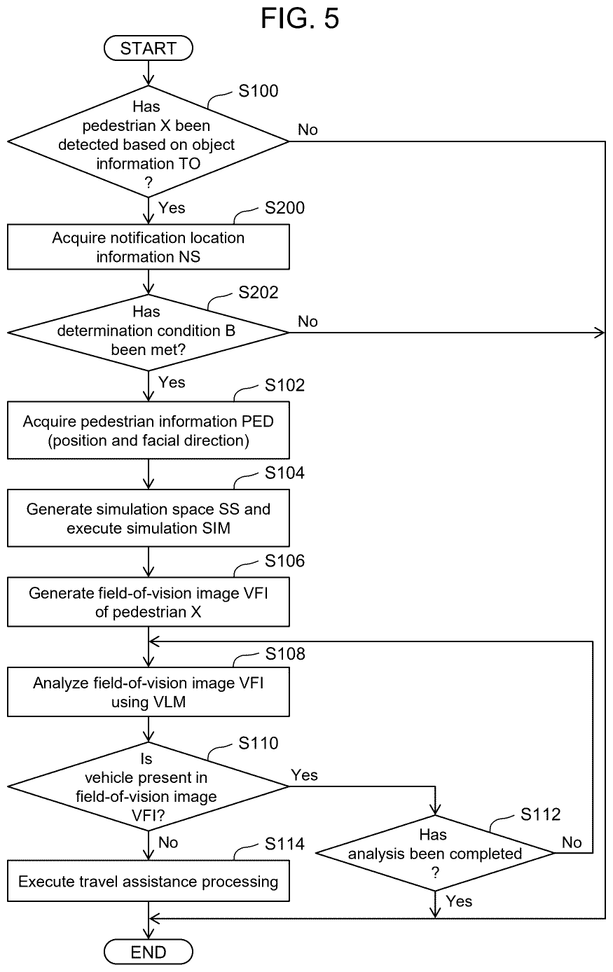

FIG. 5 is a flowchart showing another example of the flow of processing related to the travel assistance TA according to the present embodiment. The processing of this flowchart is different from the processing of the flowchart shown in FIG. 2 in the following points.

In FIG. 5, when the pedestrian X is detected based on the object information TO (step S100: Yes), the processing proceeds to step S200. In step S200, the processor 19 acquires notification location information NS. The notification location information NS is information on a location (notification location) where the notification N in the travel assistance processing was previously performed (i.e., performed in the past). The notification location information NS includes, for example, information indicating the position of the notification location, the date and time of the notification N, and the number of notifications for each notification location. The target of acquisition of the notification location information NS is the above-described notification N to at least one of the user U (notification device 15) and the travel control ECU. The vehicle that is the target of acquisition of the notification location information NS is at least one of the vehicle 2 and one or more other vehicles to which the travel assistance system according to the present disclosure is applied similarly to the vehicle 2. That is, the notification location information NS is acquired by at least one of the vehicle 2 and the one or more other vehicles where the notification N has been made. For example, the acquired notification location information NS may be transmitted to an external system such as the server 40 and collected, or may be shared between vehicles including the vehicle 2 by communicating with each other. In step S200, the processor 19 acquires the notification location information NS thus acquired, from the server 40 or the memory device 20, for example. Then, the processing proceeds to step S202.

In step S202, the processor 19 determines whether or not a determination condition B is met, based on the notification location information NS. The determination condition B is that the location where the pedestrian X is detected based on the object information TO corresponds to a location where the notification N was previously made more than a predetermined number of times or at a frequency equal to or greater than a threshold value. The location where the pedestrian X is detected can be identified from, for example, the position information on the pedestrian X included in the pedestrian information PED.

When the determination condition B is met (step S202: Yes), that is, when it can be determined that the location where the pedestrian X was detected this time in step S100 is a high-risk location, the processing proceeds to step S102. On the other hand, when the determination condition B is not met (step S202: No), the processing proceeds to END. As described above, according to the processing shown in FIG. 5, the field-of-vision prediction processing and the moving body presence determination processing are executed on the condition that the determination condition B is met.

### 2-3. Supplementary Explanation Regarding Execution of Various Kinds of Processing

The various kinds of processing shown in FIGS. 2 and 5 may be executed by one or more processors included in one or more external systems (e.g., pedestrian recognition system 30, server 40) that wirelessly communicate with the vehicle 2, instead of or in addition to the one or more processors 19 included in the in-vehicle system 10. Specifically, for example, at least one of the field-of-vision prediction processing and the moving body presence determination processing may be executed by the server 40 or by cooperation between the server 40 and the pedestrian recognition system 30. Furthermore, for example, the travel assistance processing may be executed by the server 40 or by cooperation between the server 40 and the in-vehicle system 10. For example, the server 40 may instruct the in-vehicle system 10 to execute at least one of the notification N and the travel control C.

### 3. Effect

As described above, according to the present embodiment, when a pedestrian X present in the vicinity of the vehicle 2 is detected based on the object information TO, the field-of-vision prediction processing and the moving body presence determination processing are executed. That is, based on the pedestrian information PED including the position and facial direction of the pedestrian X, a field-of-vision image VFI that represents the result of prediction of the field of vision FOV of the pedestrian X in the simulation space SS based on the object information TO is generated. Then, the output information MO indicating the result of the determination as to whether the vehicle 2 is present in the field-of-vision image VFI is output from the VLM 50 to which the field-of-vision image VFI is input. This makes it possible to assist the travel of the vehicle 2 while more appropriately grasping the predicted information (i.e., the determination result of the VLM 50) on the field of vision FOV of the pedestrian X after the pedestrian X is detected in the vicinity of the vehicle 2. In addition, as described above, the field-of-vision image VFI, which is an image of a virtual space, is generated as information indicating the field of vision FOV of the pedestrian X, making it possible for the VLM50 (multimodal generative AI model) to make a judgement.

Moreover, according to the present embodiment, when a determination result indicating that the detected pedestrian X is not present in the field-of-vision image VFI is acquired from the VLM 50, the travel assistance processing may be executed on the condition that the above-described execution condition A is met. This makes it possible to perform the travel assistance TA as needed by utilizing the predicted information on the field of vision FOV of the detected pedestrian X.

Moreover, the field-of-vision images VFI according to the present embodiment may be acquired in chronological order for the prediction target period P. Then, when the output information MO indicates that the vehicle 2 is present in the field-of-vision image VFI (step S110: Yes), the output of the output information MO from the VLM 50 may be repeatedly executed while updating the field-of-vision images VFI input to the VLM 50 in chronological order until the output information MO indicates that the vehicle 2 is not present in the field-of-vision image VFI (step S110: No) or the output of the output information MO for all of the time-series field-of-vision images VFI is completed (step S112: Yes). That is, the analysis by the VLM 50 may be performed in chronological order. The eye gaze of the pedestrian X may change over time. For example, as shown in FIG. 4A, if the vehicle 2 is present in the field-of-vision image VFI, that is, if the eye gaze of the pedestrian X is directed toward the vehicle 2, it can be said that there is little possibility that the pedestrian X will run out toward the vehicle 2. On the other hand, for example, as shown in FIG. 4B, if the vehicle 2 is not present in the field-of-vision image VFI, that is, if the eye gaze of the pedestrian X is not directed toward the vehicle 2, the possibility that the pedestrian X will run out toward the vehicle 2 is higher than that when the eye gaze is directed toward the vehicle 2. Therefore, by performing the analysis by the VLM 50 in chronological order, the situation in which the travel assistance TA is necessary can be determined more appropriately.

Moreover, the travel assistance processing according to the present embodiment may also include executing the notification N to the user U via the notification device 15. This makes it possible to notify the user U in advance of the presence of a pedestrian X that requires caution on the planned route R of the vehicle 2.

The travel assistance processing according to the present embodiment may also include the execution of the travel control C. This allows the vehicle 2 to travel safely while taking into consideration the presence of the pedestrian X. More specifically, the travel control C may include the brake control of the vehicle 2. The activation start condition of the brake control may be relaxed when the output information MO indicates that the vehicle 2 is not present in the field-of-vision image VFI compared to when the output information MO indicates that the vehicle 2 is present in the field-of-vision image VFI. This makes it possible to more appropriately address the pedestrian X running out into the roadway, which may occur when the eye gaze of the pedestrian X is not directed toward the vehicle 2 as shown in FIG. 4B, for example.

Moreover, according to the present embodiment, it may be determined based on the notification location information NS whether or not the determination condition B is met, that is, whether the location where the pedestrian X is detected based on the object information TO corresponds to a location where the notification N was previously made more than a predetermined number of times or at a frequency equal to or greater than a threshold value. Then, the field-of-vision prediction processing and the moving body presence determination processing may be executed on the condition that determination condition B is met. In other words, these two kinds of processing may be performed only in locations where there is a high risk regarding the safe driving of the vehicle 2. This makes it possible to effectively predict the field of vision FOV of the pedestrian X present around the vehicle 2 while reducing the processing load on the processor 19.

Furthermore, according to the present embodiment, the field-of-vision image VFI may be generated based on the traffic situation information TS together with the object information TO. This makes it possible to acquire a more appropriate prediction result of the field of vision FOV of the pedestrian X while also taking into consideration the traffic situations around the vehicle 2.

What is claimed is:

1. A movement assistance system for assisting movement of a moving body, the movement assistance system comprising:
one or more sensors included in one or more external systems that perform wireless communication with the moving body; and
processing circuitry configured to:
acquire object information around the moving body using the one or more sensors; and
when detecting a pedestrian around the moving body based on the object information, execute field-of-vision prediction processing and moving body presence determination processing, wherein
the field-of-vision prediction processing includes:
acquiring pedestrian information including a position and facial direction of the pedestrian, from the object information; and
field-of-vision image generation processing of generating, based on the pedestrian information, a field-of-vision image that represents a result of prediction of a field of vision of the pedestrian in a virtual space based on the object information, and
the moving body presence determination processing includes:
inputting, to a multimodal generative AI model, input information including the field-of-vision image and a prompt that instructs an output of output information indicating a result of determination as to whether or not the moving body is present in the field-of-vision image; and
causing the multimodal generative AI model to output the output information.

2. The movement assistance system according to claim 1, wherein
the processing circuitry is further configured to, when the output information indicates that the moving body is not present in the field-of-vision image, execute movement assistance processing of assisting the movement of the moving body, provided that an execution condition based on the pedestrian information is met.

3. The movement assistance system according to claim 1, wherein
the field-of-vision image generation processing includes acquiring field-of-vision images in chronological order for a target period of the prediction, and
the moving body presence determination processing includes, when the output information indicates that the moving body is present in the field-of-vision image, causing the multimodal generative AI model to output the output information while updating the field-of-vision image input to the multimodal generative AI model in chronological order until the output information indicates that the moving body is not present in the field-of-vision image or until output of the output information for all of time-series field-of-vision images is completed.

4. The movement assistance system according to claim 2, further comprising a notification device configured to notify a user of the moving body of information, wherein
the movement assistance processing includes executing a notification to notify the user of a presence of the pedestrian via the notification device.

5. The movement assistance system according to claim 2, wherein
the movement assistance processing includes executing movement control of the moving body to avoid a collision between the moving body and the pedestrian based on the pedestrian information.

6. The movement assistance system according to claim 5, wherein
the movement control includes brake control of the moving body,
the execution condition includes an activation start condition of the brake control, and
in the brake control, the processing circuitry is further configured to, when the output information indicates that the moving body is not present in the field-of-vision image, relax the activation start condition compared to when the output information indicates that the moving body is present in the field-of-vision image.

7. The movement assistance system according to claim 2, wherein
the processing circuitry is further configured, when detecting the pedestrian based on the object information, to:
acquire notification location information on a notification location where a notification was previously made to notify a presence of the pedestrian when the output information indicates that the moving body is not present in the field-of-vision image;
determine, based on the notification location information, whether or not a determination condition is met, wherein the determination condition is that a location where the pedestrian is detected based on the object information corresponds to a location where the notification was previously made more than a predetermined number of times or at a frequency equal to or greater than a threshold value; and
execute the field-of-vision prediction processing and the moving body presence determination processing, provided that the determination condition is met.

8. The movement assistance system according to claim 1, wherein
in the field-of-vision image generation processing, the processing circuitry is further configured to generate the field-of-vision image based on traffic situation information indicating a traffic situation around the detected pedestrian, together with the pedestrian information.

9. A movement assistance method executed by a computer to assist movement of a moving body, the movement assistance method comprising:
acquiring object information around the moving body using one or more sensors included in one or more external systems that perform wireless communication with the moving body; and
when detecting a pedestrian around the moving body based on the object information, executing field-of-vision prediction processing and moving body presence determination processing, wherein
the field-of-vision prediction processing includes:
acquiring pedestrian information including a position and facial direction of the pedestrian, from the object information; and
field-of-vision image generation processing of generating, based on the pedestrian information, a field-of-vision image that represents a result of prediction of a field of vision of the pedestrian in a virtual space based on the object information, and
the moving body presence determination processing includes:
inputting, to a multimodal generative AI model, input information including the field-of-vision image and a prompt that instructs an output of output information indicating a result of determination as to whether or not the moving body is present in the field-of-vision image; and
causing the multimodal generative AI model to output the output information.

10. A non-transitory computer-readable recording medium storing a movement assistance program executed by a computer to assist movement of a moving body,
the movement assistance program causing the computer to execute:
acquiring object information around the moving body using one or more sensors included in one or more external systems that perform wireless communication with the moving body; and
when detecting a pedestrian around the moving body based on the object information, executing field-of-vision prediction processing and moving body presence determination processing, wherein
the field-of-vision prediction processing includes:
acquiring pedestrian information including a position and facial direction of the pedestrian, from the object information; and
field-of-vision image generation processing of generating, based on the pedestrian information, a field-of-vision image that represents a result of prediction of a field of vision of the pedestrian in a virtual space based on the object information, and
the moving body presence determination processing includes:
inputting, to a multimodal generative AI model, input information including the field-of-vision image and a prompt that instructs an output of output information indicating a result of determination as to whether or not the moving body is present in the field-of-vision image; and
causing the multimodal generative AI model to output the output information.
